(19) United States
(12) Patent Application Publication
(10) Pub. No.: US 2024/0196144 A1
(43) Pub. Date: Jun. 13, 2024

(54) METHODS AND SYSTEM FOR DETERMINING A SOUND QUALITY OF AN AUDIO SYSTEM

(71) Applicant: HARMAN INTERNATIONAL INDUSTRIES, INCORPORATED, Stamford, CT (US)

(72) Inventors: Andrey Viktorovich FILIMONOV, Kamenki (RU); Mikhail Sergeevich KLESHNIN, Nizhny Novgorod (RU); Anna Yurievna KERBENEVA, Nizhny Novgorod (RU); Joy LYONS, Lake Forest Park, WA (US); Sean Edward OLIVE, Oak Park, CA (US)

(21) Appl. No.: 18/556,506

(22) PCT Filed: Apr. 23, 2021
(86) PCT No.: PCT/RU2021/000171

§ 371 Date: Oct. 20, 2023

(51) Int. Cl. H04R 29/00; G06N 3/084

(52) U.S. Cl. CPC H04R 29/001; G06N 3/084; H04R 2499/13

(57) ABSTRACT

A computer-implemented method for determining a scoring indicative of a sound quality of an audio system, the method comprising: sending at least one test signal to at least one reference audio system; measuring a first frequency response of the reference audio system to the test signal; receiving at least one reference scoring indicative of a sound quality of the reference audio system; supplying a training dataset comprising the first frequency response and the reference scoring to an artificial neural network; training the artificial neural network on the training dataset to predict a scoring for the audio system; sending at least one test signal to at least one production audio system; measuring a second frequency response of the production audio system; and processing an input dataset comprising the second frequency response by the artificial neural network to predict a scoring indicative of a sound quality of the production audio system.

### FIELD

The present disclosure relates to systems, methods, and devices for determining a sound quality of an audio system, in particular a car audio system. In particular, the present disclosure relates to predicting a subjective perception of an expert evaluator of an audio system.

### BACKGROUND

A key measure for the quality of an audio system, for example a consumer audio system for a vehicle, is the human perception of audio tracks as reproduced by the audio system. The sound quality can be determined by human audio expert evaluators by listening to prepared sound recordings as played by the audio system and determining a score indicative of the sound quality. As this approach directly relies on subjective perception, a plurality of expert evaluators is needed to gain objectivity. Therefore, there is an interest in predicting, by a computer-implemented method, an expert evaluator scoring based on an acoustic measurement.

The following documents relate to determining and improving the sound quality of audio systems:
Soulodre G. A. Subjective evaluation of new room acoustic measures. J. Acoust. Soc. Am., vol. 98(1), p. 294 (1995).
AES20-1996: AES recommended practice for professional audio—Subjective evaluation of loudspeakers (2008).
Gabrielsson A. et al. Perceived sound quality of reproductions with different frequency responses and sound levels. J. Acoust. Soc. Am., vol. 88(3), p. 1359 (1990).
Klippel W. Assessing the subjectively perceived loudspeaker quality on the basis of objective parameters. Audio Engineering Society Convention 88, Paper 2929 (1990).
Olive S. Method for predicting loudspeaker preference. U.S. Pat. No. 8,311,232 (2005).
Beerends J., Nieuwenhuizen K., Broek E. Quantifying Sound Quality in Loudspeaker Reproduction. J. Audio Eng. Soc., vol. 64(10), p. 784 (2016).
Ballou G. Handbook for Sound Engineers. Burlington: Focal Press. (2008).
Olive S., Welti T., Khonsaripour O. Linear model to predict listener preference ratings of headphones. Patent Application US 2019/0087739 A1 (2018).
Moore B., Tan C., Zacharov N., Mattila V. Method for predicting the perceptual quality of audio signals. Patent Application WO 2005/083921 A1 (2018).
Jong-Bae Kim Method and apparatus to measure sound quality. Patent application US 2005/0244011 A1 (2005).
Toole F. Loudspeaker measurements and their relationship to listener preferences: Part 2. J. Audio Eng. Soc., vol. 34(5), p. 323 (1986).
Kent State University Libraries. SPSS tutorials: Pearson Correlation. (2017).
Floudas C. A., Pardalos, P. (Eds.) Encyclopedia of Optimization. Boston: Springer. (2008).

### SUMMARY

Disclosed and claimed herein are methods and systems for determining a scoring indicative of a sound quality of an audio system.

A first aspect of the present disclosure relates to a computer-implemented method for determining a scoring indicative of a sound quality of an audio system. The method comprises:
sending at least one test signal to at least one reference audio system;
measuring a first frequency response of the reference audio system to the test signal;
receiving at least one reference scoring indicative of a sound quality of the reference audio system;
supplying a training dataset comprising the first frequency response and the reference scoring to an artificial neural network;
training the artificial neural network on the training dataset to predict a scoring for the audio system;
sending at least one test signal to at least one production audio system;
measuring a second frequency response of the production audio system; and
processing an input dataset comprising the second frequency response by the artificial neural network to predict a scoring indicative of a sound quality of the production audio system.

The training dataset may consist of the at least one first frequency response and the at least one reference scoring, or alternatively, comprise additional data. Processing the second frequency response may include processing, by the artificial neural network, the additional data comprised in the input dataset, as described with respect to the embodiments discussed below.

Once the artificial neural network is trained on a plurality of known reference audio systems, it may be used in the inference step to predict the sound quality of a production audio system. The production audio system, which may be, for example, a prototype of a new audio system, thus need not be analyzed by the evaluators. Rather, a single measurement run to determine the frequency response with subsequent processing may be sufficient to predict the score.

The sound quality is predicted by a neural network that is not restricted by assuming a particular form of a functional relationship between the frequency response and the sound quality. In particular, no analytic, e.g. linear, model between a frequency response and a scoring is needed.

In an embodiment, the reference scoring is indicative of a subjective sound quality of the reference audio system and/or is determined by at least one human expert evaluator.

Thereby, an artificial neural network is first trained on a plurality of audio systems with a plurality of human expert evaluators, to predict a scoring related to the quality of an audio system. The scoring may be predicted for each of the evaluators, and/or an average score may be determined. Thereby, weights in the artificial neural network may be determined to locally minimize a loss function indicative of a discrepancy between the reference scoring and the predicted scoring. For example, a mean squared error may be used as a loss function.

In a further embodiment, measuring a first and/or second frequency response comprises detecting, at a measurement position, sound emitted by the reference and/or production audio system.

Measuring the sound may be effected by a sound recording device, such as a microphone. Standard hardware may be used, thus eliminating the need for any specialized measurement devices.

In a further embodiment, the reference scoring is indicative of a subjective sound quality of the reference audio system at the recording position. In particular, a recording device to record the frequency may be positioned at a position where a user would typically position his head, which may also be the position of the head of the expert evaluator. Thereby, the frequency response is determined that takes into account not only properties of the audio system, but also the environment, and that relates directly to the sound as perceived by a typical user. If, for example the audio system is a car audio system, a recording position may be in proximity to a headrest of the car.

In a further embodiment, the test signal comprises noise. In particular, pink noise may be used. Noise covers a wide frequency range, and its frequency response is therefore sensitive to audio system and environment properties at all frequencies of the frequency range. In particular, the whole frequency range of the audio system may be characterized.

In contrast, the assessments of the human expert evaluators may be based on one or more predefined standard recordings, for example standard audio tracks comprising music or voices.

In a further embodiment, measuring a first and/or second frequency response comprises recording sound in a production environment. A production environment may be any environment in which the audio system is adapted to or can be used. For example, for a car audio system, first and/or second frequency responses may be measured in a vehicle.

In a further embodiment, measuring a first and/or second frequency response comprises recording sound emitted by the reference and/or production audio system, wherein the gain of each reference and/or production audio systems is set to one predetermined level. If frequency response depends linearly on the gain, only one measurement at a fixed gain is needed to obtain sufficient information to predict the scoring. Additional measurements, such as scanning gains, are not needed.

Alternatively, the measurements can be carried out in an anechoic chamber. The present disclosure is, however, not limited to such setups. The use of an artificial neural network is particularly useful to take the environmental effects into account, without any additional model being necessary.

In a further embodiment, the reference and/or production audio system comprises a vehicle audio system. The production environment may then comprise a vehicle. Thereby, both the construction of the audio system and the configuration within the vehicle can be facilitated to take into account environmental effects, which may be determined by the positioning of speakers and other objects in the vehicle, and/or noise when driving.

In a further embodiment, the training dataset and/or the input dataset further comprise data indicative of a brand, a model, and/or characteristics of the audio system and/or components of the audio system. Supplying these data to the artificial neural network during the training phase may facilitate the convergence of the training. Upon inference, information upon the configuration and/or components of the audio system may be supplied to an appropriate artificial neural network to increase the prediction accuracy.

A further embodiment comprises visualizing the predicted scoring for the production audio system by a display device. Thereby, the results can be displayed quickly, which allows, e.g. improving the sound quality by adjusting settings of the production audio system and observing directly the effect on the scoring.

In a further embodiment, the artificial neural network comprises a fully connected artificial neural network. Input and output layers of the artificial neural network may then be adapted to receive the frequency response and—optionally—additional information, and yield predictions for the scorings. The structure and size of the hidden layers may be adapted to allow a sufficient accuracy for the predictions. Training may be done by known techniques, such as supervised learning, e.g. backpropagation.

A second aspect of the present disclosure relates to a system for determining a scoring indicative of a sound quality of an audio system. The system comprises at least one test signal generator, at least one frequency response detector, at least one input unit, and a computing device.

The test signal generator is configured to send at least one test signal to at least one audio system.

The frequency response detector is configured to measure, a first frequency response of at least one reference audio system to the test signal. The frequency response detector is further configured to measure a second frequency response of at least one production audio system.

The input unit is configured to receive at least one reference scoring indicative of a sound quality of the reference audio system.

The computing device is configured to execute the following steps:
supplying a training dataset comprising the first frequency response and the reference scoring to an artificial neural network;
training the artificial neural network on the training dataset to predict a scoring for the audio system; and
processing an input dataset comprising the second frequency response by the artificial neural network to predict a scoring indicative of a sound quality of the production audio system.

A third aspect of the present disclosure relates to the use of the above-mentioned system to predict a scoring indicative of a sound quality of an audio system.

All embodiments and properties of the first aspect of the disclosure are also applicable of the second and the third aspect.

### BRIEF DESCRIPTION OF THE DRAWINGS

The features, objects, and advantages of the present disclosure will become more apparent from the detailed description set forth below when taken in conjunction with the drawings in which like reference numerals refer to similar elements.

FIG. 1 shows a flow diagram of a method 100 for training an artificial neural network according to an embodiment;

FIG. 2 shows a flow diagram of a method 200 for using an artificial neural network to predict the sound quality of a production audio system, according to an embodiment;

FIG. 3 shows a block diagram of a system 300 for determining a scoring indicative of a sound quality of an audio system according to an embodiment;

FIG. 4 shows a block diagram of a training dataset 400 according to an embodiment; and

FIG. 5 depicts a schematic block diagram of an artificial neural network 500 according to an embodiment.

### DETAILED DESCRIPTION OF THE PREFERRED EMBODIMENTS

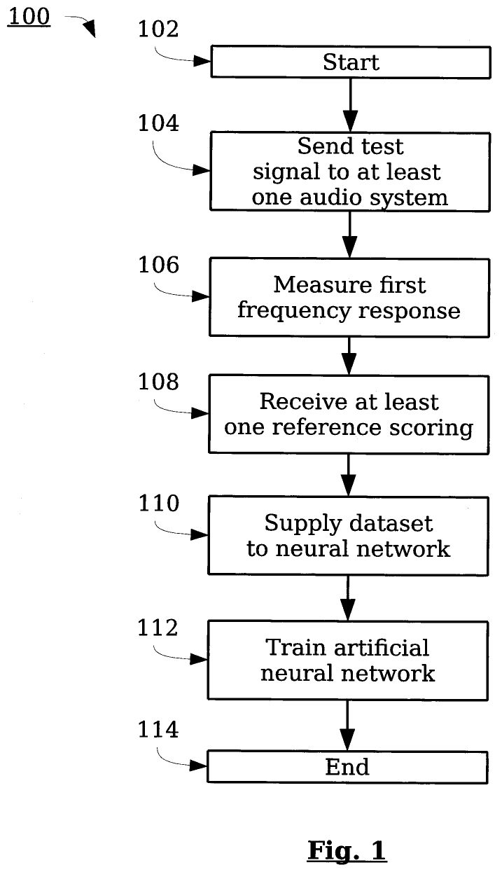

FIG. 1 shows a flow diagram of a method 100 for training an artificial neural network according to an embodiment.

The method begins at 102. A test signal is sent, 104, to at least one test audio system. The test signal may comprise a type of noise, for example pink noise, or a predefined test recording. Using noise allows predicting the sound quality for a wide frequency range. The audio system may comprise a reference audio system, which is used to train the artificial neural network. A plurality of different audio systems of different manufacturers, and/or types may be used. The audio systems may be placed in an anechoic chamber or in a production environment. Placing the audio systems in a production environment allows training the artificial neural network in a way such that effects of the production environment are taken into account, and the trained artificial neural network predicts the scoring more precisely. In an illustrative embodiment, the production environment may be a vehicle interior, and a plurality of car audio systems of different manufacturers and/or types is used as reference audio systems.

At 106, a frequency response is measured for each of the audio systems. Measuring the frequency response may comprise recording the sound emitted by the audio system at a recording position to generate an impulse response. The recording position may be a position where a user of the system would typically be placed. In the illustrative embodiment, a recording position may be located near a driver's headrest of the vehicle. Alternatively, a recording position may be chosen differently. Measuring the frequency response may further comprise transforming the impulse response into a frequency space, for example by applying a Fast Fourier Transform (FFT) or Continuous Wavelet Transform (CWT).

At 108, at least one reference scoring related to the reference audio system is received. The reference scoring may be given by human audio system expert evaluators for a subjective quality of the audio system, and comprise one or more values on a predetermined scale, for example integers from 0 to 9. The reference scoring may be indicative of a sound quality of the audio system, compared to a predetermined standardized reference system, preferably in a standardized reference environment. The expert evaluators could have determined the reference scoring by listening to the audio system as it is playing a standardized track or track list, comprising one or more predetermined audio recordings, which may comprise music or voices.

At 110, the frequency response and the reference scoring are supplied as a training dataset to the neural network. Furthermore, in an alternative embodiment, a code identifying the brand, the model, and/or characteristics of the audio system is supplied to the neural network in addition to the frequency response and the reference scoring. Characteristics may comprise the number of channels, the presence of a predetermined type of speaker, a maximum output sound power, relative positions of speakers, and/or declared frequency responses of the individual speakers. The frequency response and, if applicable, the code, are entered into one or more inputs of the artificial neural network. The reference scoring is supplied as a desired output.

At 112, the artificial neural network is trained on the training dataset. By training, the weights may be determined to reduce the discrepancy between the reference scoring and the predicted value until a local minimum value for the discrepancy has been found. Known techniques for training an artificial neural network by locally minimizing a loss function may be used, for example backpropagation. The method ends, 114 when the artificial neural network is trained.

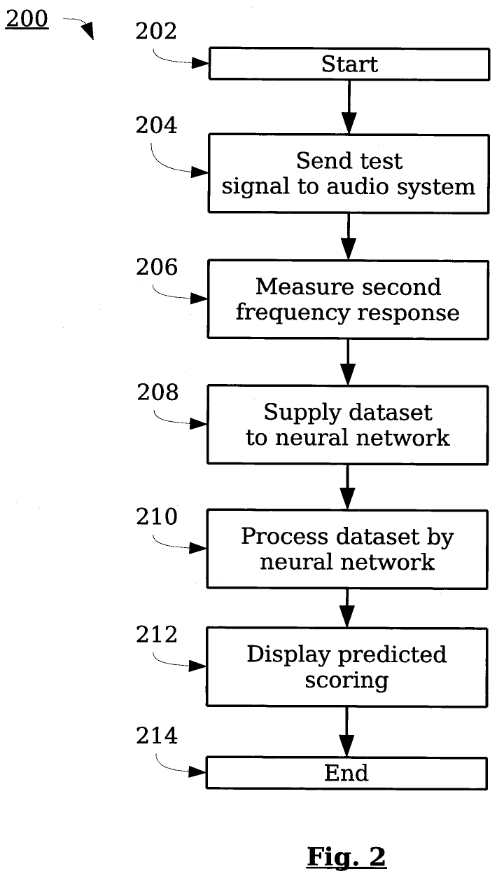

FIG. 2 shows a flow diagram of a method 200 for using an artificial neural network to predict the sound quality of a production audio system, according to an embodiment. Method 200 may be used, for example, to predict a sound quality of a new or modified prototype of a vehicle audio system. The method 200 comprises using an artificial neural network, that has been trained, for example by the method 100.

The method begins at 202. At 204, a test signal is sent to the audio system for output. This test signal is the same as the test signal used for training the artificial neural network as described with reference to step 104.

The audio systems may be placed in an anechoic chamber or in a production environment. Placing the audio system in a production environment allows taking effects of the production environment into account. Furthermore, the audio system, which may comprise a prototype or one or more prototype components, can be developed and/or adapted to the production environment, in order to yield a high sound quality in this specific production environment. The determination of the sound quality by method 200 may then allow determining the effect of an adaptation or development step on the sound quality. In the illustrative embodiment, the production environment may be a vehicle interior, and the audio system is to be adapted to the vehicle.

At 206, a second frequency response is measured for the production audio system. Step 206 may comprise recording an impulse response and converting the impulse response to frequency space as described with respect to step 106. In particular, the device for recording the impulse response may be placed into a listener's position. At 208, the frequency response is supplied to the neural network as a production dataset. At 210, the production dataset is processed by the artificial neural network. The output of the artificial neural network is displayed at 212 and predicts the sound quality by giving a score on the scale used by the evaluators. Thereby, method 200 allows determining the sound quality of the audio system quickly, since only a single measurement is done, rather than evaluating the sound system by human expert evaluators. The measurement may be done at one fixed gain or volume setting of the audio system. Furthermore, the measurement can be done with standard equipment.

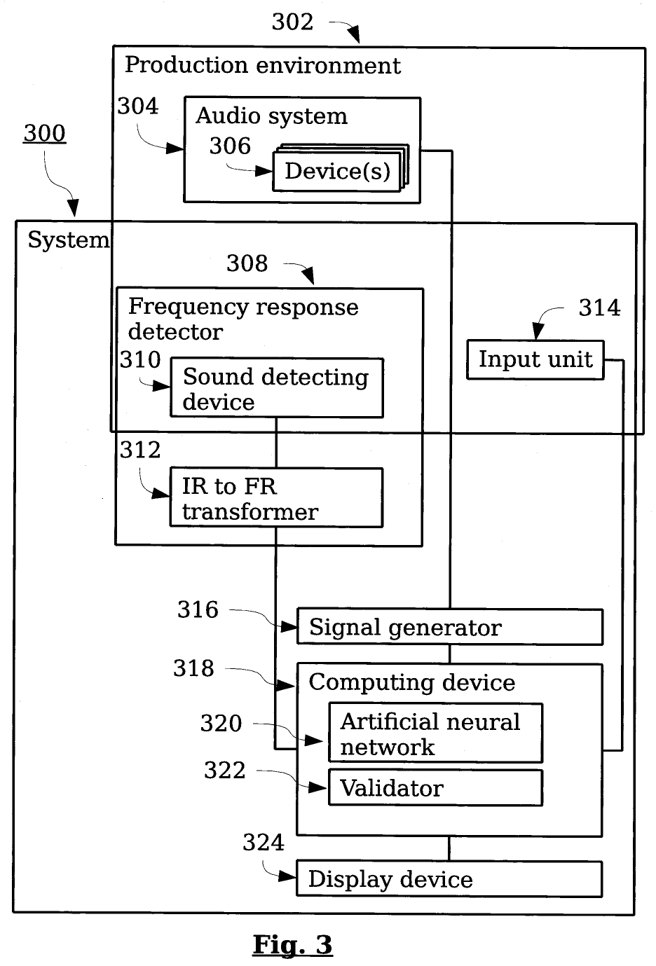

FIG. 3 shows a block diagram of a system 300 for determining a scoring indicative of a sound quality of an audio system according to an embodiment. The audio system 304 comprises one or more devices 306 and is comprised in a production environment 302. In an illustrative embodiment, the audio system 304 may be a car audio system and may comprise devices 306, e.g. one or more speakers. The production environment 302 may comprise, for example, a vehicle. The system 300 comprises components 308-324, which may be entirely or in part comprised in the production environment.

In this example, the system comprises a signal generator 316 to generate a test signal. As a test signal, noise, e.g. pink noise may be chosen. The test signal is sent to the audio system for output. The audio system may be set to a predetermined test configuration, including setting the gain to a predetermined level. If the audio system and the environment react linearly to gain, only one measurement is effected at a constant gain. The frequency response of the audio system is then determined by the frequency response detector 308: The sound emitted by the audio system in time domain is then, i.e. the impulse response is measured by the sound recording device 310, e.g. a microphone. The sound recording device may be positioned at a place where the head of a user of the system is typically located, such as in proximity to a headrest of a driver's seat in case of a car audio system. The transformer 312 transforms the impulse response to a frequency response. This step can comprise, e.g., application of a Fast Fourier Transform (FFT) or a Continuous Wavelet Transform (CWT). The frequency response is then sent to the computing device 318 to be input into the artificial neural network 320. If the audio system is a reference audio system to train the artificial neural network 320, this input may then be included in a first training data subset, thus executing steps 104 and 106 of method 100 (FIG. 1). However, if the audio system is a production audio system, the input can be included into an input to be processed by a trained artificial neural network 320 during an inference phase, as exemplified in steps 204 and 206 of method 200 (FIG. 2). In this exemplary embodiment, the transformer 312 and the signal generator 316 are shown as distinct from the computing device 318. However, they may be part of the computing device in embodiments. In further embodiments, they may be implemented in software.

The system 300 of this exemplary embodiment further comprises an input unit 314 to receive an input indicative of the scoring by audio expert evaluators. The input may comprise any quantified measure of the quality of the audio system. For example, the evaluators may give a rating for the quality of the audio system based on a predefined number of tracks played by the audio system. A score may be given as a numeral value, e.g. on a scale from 0 to 9, and indicate how the audio system compares to a predetermined reference audio system. The score may then be used as a second training data subset by the validator 322 to train the artificial neural network 320.

The artificial neural network 320 may process an input dataset comprising a frequency response, to predict the evaluators' scorings. The input may further comprise information on audio system, such as the brand, the model, and/or characteristics of the audio system, and is supplied to the neural network in addition to the frequency response and the reference scoring. Characteristics may comprise the number of channels, the presence of a predetermined type of speaker, a maximum output sound power, relative positions of speakers, and/or declared frequency responses of the individual speakers. The output may comprise a plurality of scorings for a predetermined set of evaluators, so that the artificial neural network is configured to predict which score each evaluator would have given to the audio system. However, other output configurations may be chosen. For example, an output of the artificial neural network 320 may comprise one or more average scores calculated from predetermined groups of evaluators, or other values that are algorithmically derivable from the scorings of the evaluators.

The validator 322 is configured to compare the output of the artificial neural network 320 to the second training data subset during a training phase, upon processing of the first training data subset. Thereby, the weights of the artificial neural network 320 can be determined so that a scoring indicative of the sound quality based on individual scorings of a given set of evaluators is predicted, by locally minimizing the discrepancy of the output with the second training data subset. This step may be done by known methods for training a neural network, for example by calculating the mean squared error as a loss function and determining a local minimum for the loss function.

Upon inference, the scoring may be determined for a new audio system, such as a prototype audio system. The scorings, a scoring distribution, or an average may be output by the display device 324. Thereby, during development of a new audio system, the effects of modifications to the prototype may be tested within a short timeframe.

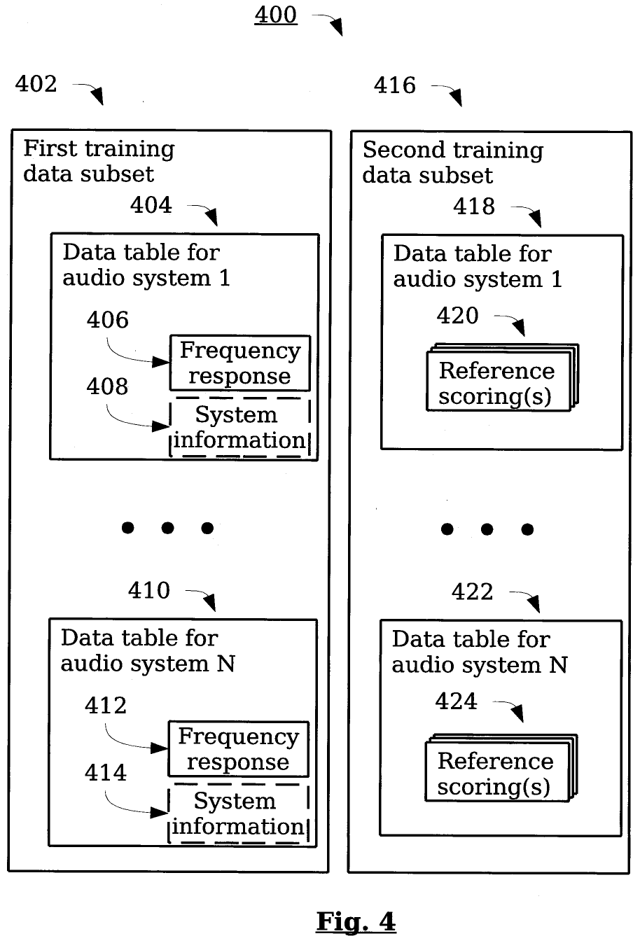

FIG. 4 shows a block diagram of a training dataset 400 according to an embodiment. The training dataset 400 comprises a first training data subset, which comprises N data tables 404, 410, each of which is related to one of N reference audio systems. In embodiments, a single data table may refer to a unique audio system, or a plurality of data tables may be related to the same audio system, wherein each data table is related to a set of settings of the audio system. Each data table 404, 410 comprises a frequency response 406, 412 recorded for the audio system. Optionally, it may comprise information 408, 414, on the audio system, such as a code identifying the brand, the model, and/or characteristics of the audio system.

The second training data subset may comprise a data table, 418, 422 for each audio system, which comprises one or more expert reference scorings 420, 424. The artificial neural network may be trained to predict the scorings for each audio system.

Upon inference, a data table comprising frequency response and, optionally, also system information may then be processed to predict the scorings.

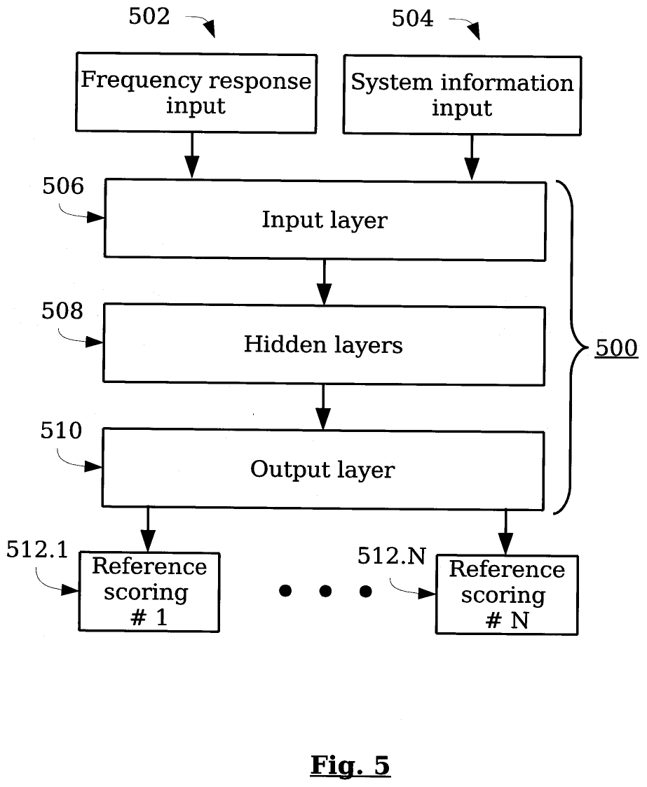

FIG. 5 depicts a schematic block diagram of an artificial neural network 500 according to an embodiment. The input layer 506 is configured to accept both a frequency response input 502 and a system information input 504. Both inputs may be used both on training and inference. In an alternative embodiment, the input layer may be adapted to accept only a frequency response input. In that case, only the frequency response is used as an input, which reduces the complexity when training and applying the artificial neural network. However, the prediction accuracy may be lower than when using the system information input 504. The hidden layers may comprise fully connected perceptrons. The number and structure of the cells may be adapted to the dataset and the necessary accuracy. The output layer 510 is configured to yield the N reference scorings 512.1 . . . 512.N, which predict the scorings and indicate the audio quality of the system.

### REFERENCE SIGNS

100 Method
102-114 Steps of method 100
200 Method
202-114 Steps of method 200
300 System
302 Production environment
304 Audio system
306 Device(s)
308 Frequency response detector
310 Sound detecting device
312 Impulse response to frequency response transformer
314 Input unit
316 Signal generator
318 Computing device
320 Artificial neural network
322 Validator
324 Display device
400 Training dataset
402 First training data subset
404 First data table for audio system 1
406 Frequency response data
408 System information
410 First data table for audio system N
412 Frequency response data
414 System information
416 Second training data subset
418 Second data table for audio system 1
420 Reference scoring(s)
422 Second data table for audio system N
424 Reference scoring(s)

1. A computer-implemented method for determining a scoring indicative of a sound quality of an audio system, the method comprising:
sending at least one test signal to a reference audio system;
measuring a first frequency response of the reference audio system to the at least one test signal;
receiving at least one reference scoring indicative of a sound quality of the reference audio system;
supplying a training dataset comprising the first frequency response and the reference scoring to an artificial neural network;
training the artificial neural network using the training dataset to predict a scoring for the reference audio system;
sending at least one test signal to a production audio system;
measuring a second frequency response of the production audio system; and
processing, by the artificial neural network, an input dataset comprising the second frequency response to predict a scoring indicative of a sound quality of the production audio system.

2. The method of claim 1, wherein the reference scoring is indicative of a subjective sound quality of the reference audio system and/or is determined by at least one human expert evaluator.

3. The method of claim 1, wherein:
measuring the first frequency response comprises detecting, at a measurement position, sound emitted by the reference audio system; or
measuring the second frequency response comprises detecting, at the measurement position, sound emitted by the production audio system.

4. The method of claim 3, wherein the reference scoring is indicative of a subjective sound quality of the reference audio system at the measurement position.

5. The method of claim 1, wherein the at least one test signal comprises noise.

6. The method of claim 1, wherein measuring the first frequency response or the second frequency response comprises recording sound in a production environment.

7. The method of claim 1, wherein:
measuring the first frequency response comprises recording sound emitted by the reference audio system, wherein a gain of the reference audio system is set to a predetermined level; or
measuring the second frequency response comprises recording sound emitted by the production audio system, wherein the gain of the production audio system is set to the predetermined level.

8. The method of claim 1, wherein the reference audio system and/or the production audio system comprises a vehicle audio system.

9. The method of claim 1, wherein:
the training dataset further comprises data indicative of one or more of a brand, a model or characteristics of the reference audio system and/or components of the reference audio system; or
the input dataset further comprises data indicative of one or more of a brand, a model, or characteristics of the production audio system and/or components of the production audio system.

10. The method of claim 1, further comprising displaying the predicted scoring for the production audio system on a display device.

11. (canceled)

12. A system for determining a scoring indicative of a sound quality of an audio system, the system comprising:
at least one test signal generator configured to send at least one test signal to at least one audio system;
at least one frequency response detector to measure;
a first frequency response of a reference audio system to the at least one test signal; and
a second frequency response of a production audio system;
at least one input unit to receive, at least one reference scoring indicative of a sound quality of the reference audio system; and
a computing device configured to:
supply a training dataset comprising the first frequency response and the reference scoring to an artificial neural network;
train the artificial neural network using the training dataset to predict a scoring for the reference audio system; and
process, using the artificial neural network, an input dataset comprising the second frequency response to predict a scoring indicative of a sound quality of the production audio system.

13. The system of claim 12, wherein the reference scoring is indicative of a subjective sound quality of the reference audio system and/or is determined by at least one human expert evaluator.

14. The system of claim 12, further comprising a sound recording device, wherein:
measuring the first frequency response comprises recording sound emitted by the reference audio system at a recording position relative to the reference audio system using the sound recording device; or
measuring the second frequency response comprises recording sound emitted by the production audio system at the recording position relative to the production audio system using the sound recording device.

15. The system of claim 14, wherein the reference scoring is indicative of a subjective sound quality of the reference audio system at the recording position.

16. The system of claim 12, wherein the at least one test signal comprises noise.

17. The system of claim 12, wherein measuring the first frequency response or the second frequency response comprises recording sound in a production environment.

18. The system of claim 12, wherein:
measuring the first frequency response comprises recording sound emitted by the reference audio system, wherein a gain of the reference audio system is set to a predetermined level; or
measuring the second frequency response comprises recording sound emitted by the production audio system, wherein the gain of the production audio system is set to the predetermined level.

19. The system of claim 12, wherein the reference audio system and/or the production audio system comprises a vehicle audio system.

20. The system of claim 12, wherein:
the training dataset further comprises data indicative of one or more of a brand, a model or characteristics of the reference audio system and/or components of the reference audio system; or
the input dataset further comprises data indicative of one or more of a brand, a model, or characteristics of the production audio system and/or components of the production audio system.

21. The system of claim 12, further comprising a display device configured to display the predicted scoring for the production audio system.

22-23. (canceled)
